(19) United States
(12) Patent Application Publication
(10) Pub. No.: US 2014/0198001 A1
(43) Pub. Date: Jul. 17, 2014

(54) OUTER TYPE ANTENNA STRUCTURE

(71) Applicant: OWITEK TECHNOLOGY LTD., Taipei City (TW)

(72) Inventor: Chun-Heng LEE, Taipei City (TW)

(73) Assignee: Owitek Technology Ltd., Taipei City (TW)

(21) Appl. No.: 13/740,956

(22) Filed: Jan. 14, 2013

(51) Int. Cl. H01Q 1/22

(52) U.S. Cl. CPC H01Q 1/22
USPC 343/720; 343/873

(57) ABSTRACT

The invention relates to an outer type antenna structure comprising: a frame; an antenna arranged in the frame, the antenna extending to have a pin outside of the frame; and a connector. The antenna is integrated to the connector. The location of the antenna arranged in the portable electrically communicative device may be not limited so that the distribution of the antennas becomes easy. Therefore, the signal interference among the antennas can be reduced.

### BACKGROUND OF THE INVENTION

1. Field of the Invention

The present invention relates to an antenna, and more in particular, to an outer type antenna structure which can integrate to a connector.

2. Related Art of the Invention

Currently, the portable electrically communicative device is widely applied in a various fields. The portable electrically communicative device may provide users various functions of wireless internet, digital television, FM radio broadcast, navigation and positioning. However, in order to achieve the various functions of wireless internet, digital television, FM radio broadcast, navigation and positioning, the portable electrically communicative device have to be arranged a plurality of antennas therein.

The portable electrically communicative device is directed to be miniaturized, so that the space between housing and a circuit board of the device is finite. The location of the antenna arranged in the portable electrically communicative device may be limited so that the proper distribution of the antennas becomes difficult. Therefore, the signal interference among the antennas can be increased.

### SUMMARY OF THE INVENTION

It is an object of the invention to provide an outer type antenna structure which can integrate with a connector to solve the above-described drawback of the conventional portable electrically communicative device. The location of the antenna arranged in the portable electrically communicative device may be not limited so that the distribution of the antennas becomes easy. Therefore, the signal interference among the antennas can be reduced.

In order to achieve the above-described object, the invention provides a first aspect of an outer type antenna structure comprising: a substrate; an antenna arranged in the frame, the antenna extending to have a pin outside of the frame. The frame may be material of plastics or rubbers. The frame may further include an absorber. The absorber may be ferrite or steel which has a high permeability. The antenna may be a metallic wire or low temperature co-fired multi-layer ceramic. The antenna may be buried in the frame by a winding or a plurality of segments.

In order to achieve the above-described object, the invention provides a second aspect of an outer type antenna structure comprising: a connector; a frame surrounded outside of the connector; and an antenna arranged in the frame, the antenna extending to have a pin outside of the frame. The connector further includes a case having material of metal. The frame may surround outside of the case. The connector may be an electrical connector or a composite electrical connector selected from the group consisting of USB, mini USB, micro USB, HDMI, diplayport and RJ-45. Alternatively, the connector may be a 3.5 mm phone jack. The frame may be material of plastics or rubbers. The frame may further include an absorber. The absorber may be ferrite or steel which has a high permeability. The antenna may be a metallic wire or low temperature co-fired multi-layer ceramic. The antenna may be buried in the frame by a winding or a plurality of segments. The connector further includes a case having material of plastic.

In order to achieve the above-described object, the invention provides a third aspect of an outer type antenna structure comprising: a connector; a frame attached on a panel of the connector; and an antenna arranged in the frame, the antenna extending to have a pin outside of the frame. The connector further includes a case having material of metal. The connector may be an electrical connector or a composite electrical connector selected from the group consisting of USB, mini USB, micro USB, HDMI, diplayport and RJ-45. Alternatively, the connector may be a 3.5 mm phone jack. The frame may be material of plastics or rubbers. The frame may further include an absorber. The absorber may be ferrite or steel which has a high permeability. The antenna may be a metallic wire or low temperature co-fired multi-layer ceramic. The antenna may be buried in the frame by a winding or a plurality of segments. The connector further includes a case having material of plastic.

In order to achieve the above-described object, the invention provides a fourth aspect of an outer type antenna structure comprising: a connector having a plastic housing; and an antenna is arranged in the plastic housing, the antenna extending to have a pin outside of the plastic housing. The connector may be an electrical connector or a composite electrical connector selected from the group consisting of USB, mini USB, micro USB, HDMI, diplayport and RJ-45. Alternatively, the connector may be a 3.5 mm phone jack. The antenna may be a metallic wire or low temperature co-fired multi-layer ceramic. The antenna may be buried in the plastic housing by a winding or a plurality of segments.

In order to achieve the above-described object, the invention provides a fifth aspect of an outer type antenna structure comprising: a connector having a plastic housing, the plastic housing having a position in front of an opening for disposing a frame; and an antenna arranged in the frame, the antenna extending to have a pin outside of the frame. The connector may be an electrical connector or a composite electrical connector selected from the group consisting of USB, mini USB, micro USB, HDMI, diplayport and RJ-45. Alternatively, the connector may be a 3.5 mm phone jack. The antenna may be a metallic wire or low temperature co-fired multi-layer ceramic. The antenna may be buried in the frame by a winding or a plurality of segments.

### DESCRIPTION OF THE DRAWINGS

FIG. 1 schematically shows a perspective view of an outer type antenna structure of a first embodiment of the invention.

FIG. 2 schematically shows a disconnected state of an outer type antenna structure and a connector of the first embodiment of the invention.

FIG. 3 schematically shows a connected state of an outer type antenna structure and a connector of the first embodiment of the invention.

FIG. 4 shows a state in use of the outer type antenna structure of the first embodiment of the invention.

FIG. 5 schematically shows a connected state of an outer type antenna structure and a connector of a second embodiment of the invention.

FIG. 6 schematically shows a state in use of the outer type antenna structure of the second embodiment of the invention.

FIG. 7 schematically shows an integration of an outer type antenna structure and a connector of a third embodiment of the invention.

FIG. 8 schematically shows an integration of an outer type antenna structure and a connector of a fourth embodiment of the invention.

FIG. 9 schematically shows a disconnected state of an outer type antenna structure and a connector of a fifth embodiment of the invention.

FIG. 10 schematically shows a cross-sectional view of a connected state of an outer type antenna structure and a connector of the fifth embodiment of the invention.

### DETAILED DESCRIPTION OF THE INVENTION

The present invention will be apparent from the following detailed description, which proceeds with reference to the accompanying drawings. The accompanying drawings are not meant to be construed in a limiting sense, which are only for reference and explanation.

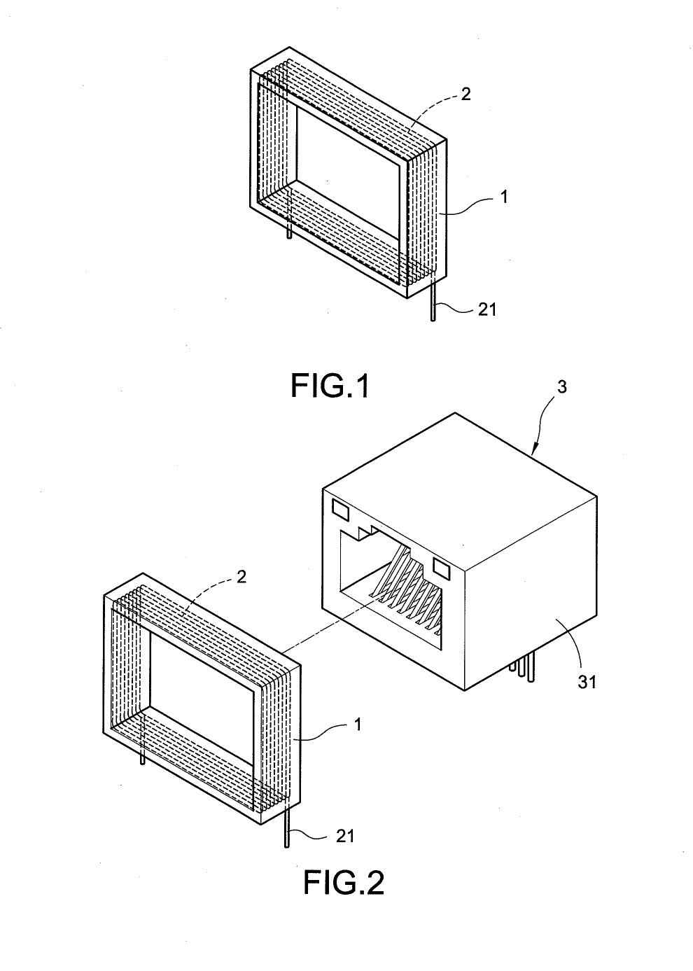

Please refer to FIG. 1. FIG. 1 schematically shows a perspective view of an outer type antenna structure of a first embodiment of the invention. As shown in FIG. 1, the invention provides an outer type antenna structure including a frame 1 and an antenna 2.

The frame 1 may be material of plastics or rubbers. The frame may further include ferrite or steel which is used as an absorber for absorbing an emitting electric wave. The steel is preferred to have a high permeability. The frame 1 may surround outside of a connector (not shown in the drawings) or attach on a rim panel of an opening of the connector. Moreover, the frame 1 has a shape directed to the outer shape of the connector.

The antenna 2 may be a metallic wire or low temperature co-fired multi-layer ceramic. The antenna 2 may be buried in the frame 1 by a winding or a plurality of segments. The antenna 2 may extend to have at least one pin 21 outside of the frame 1.

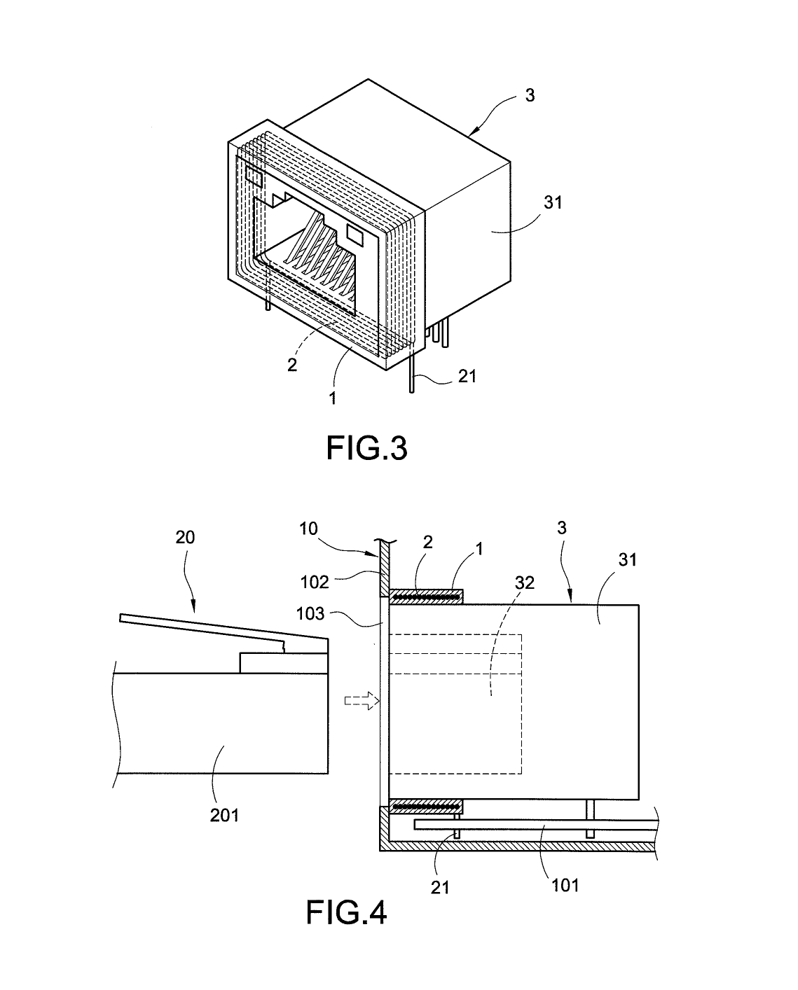

Please refer to FIGS. 2 and 3. FIGS. 2 and 3 respectively schematically show disconnected state and connected state of an outer type antenna structure and a connector of a first embodiment of the invention. As show in FIGS. 2 and 3, in use of the outer type antenna structure of the embodiment of the invention, the frame 1 may surround outside of a case 31 of the connector 3, preferably adjacent a position of an opening of the case 31 to integrate the outer type antenna structure and the connector 3 so that the connector 3 is able to emit and receive a signal. The case 31 of connector 3 is material of metal or plastic. In use of the connector 3 integrated with the outer type antenna structure connecting to an electronic device (not shown in FIGS. 2 and 3), the connector 3 may provide a function of signal transmission, and the outer type antenna structure may provide a function of wireless signal emission and receiving to the electronic device or connection to interne. In the embodiment, the connector 3 may be an electrical connector or a composite electrical connector selected from the group consisting of USB, mini USB, micro USB, HDMI, diplayport and RJ-45. Alternatively, the connector 3 may be 3.5 mm phone jack.

Please refer to FIG. 4. FIG. 4 shows a state in use of the outer type antenna structure of the first embodiment of the invention. As show in FIG. 4, after completing integration of the outer type antenna structure and the connector 3, the connector 3 is electrically connected to a circuit board 101 of an electronic device 10, and the outer type antenna structure corresponds to a hole 103 of a housing 102 of the electronic device 10. Also, the pin 21 of the antenna 2 is electrically connected to the circuit board 101.

As a plug 201 of a transmission line 20 is inserted into an opening 32 of the connector 3 through the hole 103 of the electronic device 10, the connector 3 and the transmission line 20 may provide a function of signal transmission, and a signal which is handled by the circuit board 101 may be emitted from the antenna 2 of the outer type antenna structure through the pin 21, and a signal received from the antenna 2 may be transmitted to the circuit board 101 through the pin 21.

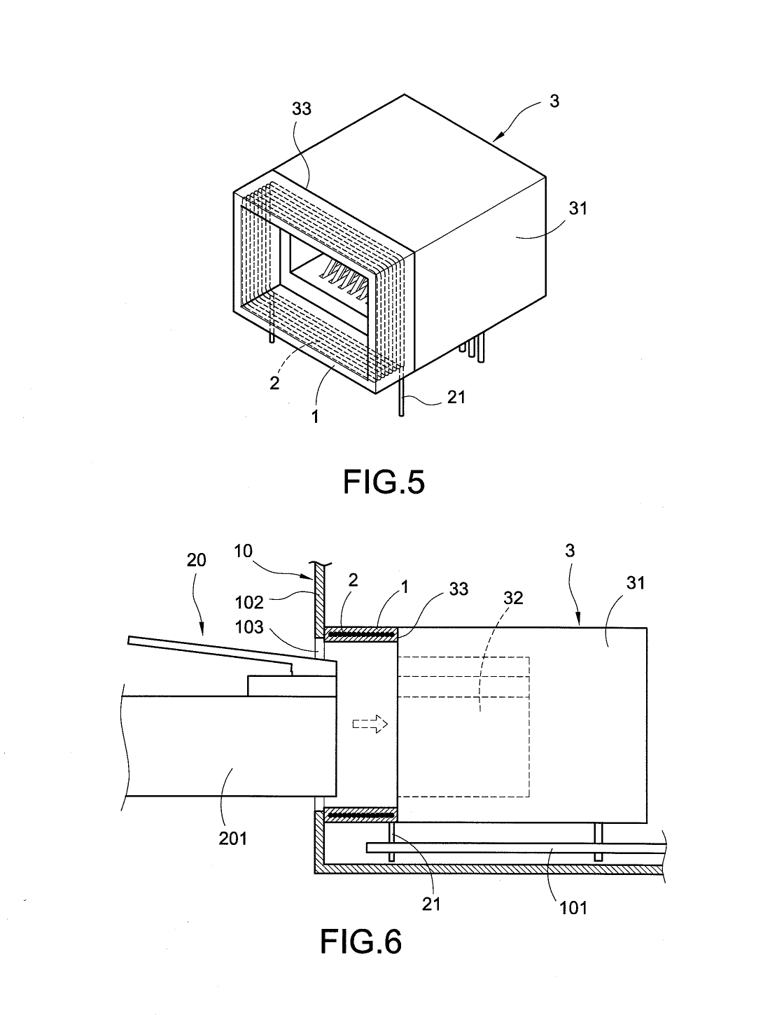

Please refer to FIGS. 5 and 6. FIG. 5 schematically shows a connected state of an outer type antenna structure and a connector of a second embodiment of the invention. FIG. 6 shows a state in use of the outer type antenna structure of the second embodiment of the invention. As show in FIG. 5, the outer type antenna structure may be attached on a panelrim 33 of an opening of the connector 3.

As show in FIG. 6, after completing integration of the outer type antenna structure and the connector 3, the connector 3 is electrically connected to a circuit board 101 of an electronic device 10, and the outer type antenna structure corresponds to a hole 103 of a housing 102 of the electronic device 10. Also, the pin 21 of the antenna 2 is electrically connected to the circuit board 101.

Please refer to FIG. 6 again. As a plug 201 of a transmission line 20 is inserted into an opening 32 of the connector 3 through the hole 103 of the electronic device 10, the connector 3 and the transmission line 20 may provide a function of signal transmission, and a signal which is handled by the circuit board 101 may be emitted from the antenna 2 of the outer type antenna structure through the pin 21, and a signal received from the antenna 2 may be transmitted to the circuit board 101 through the pin 21.

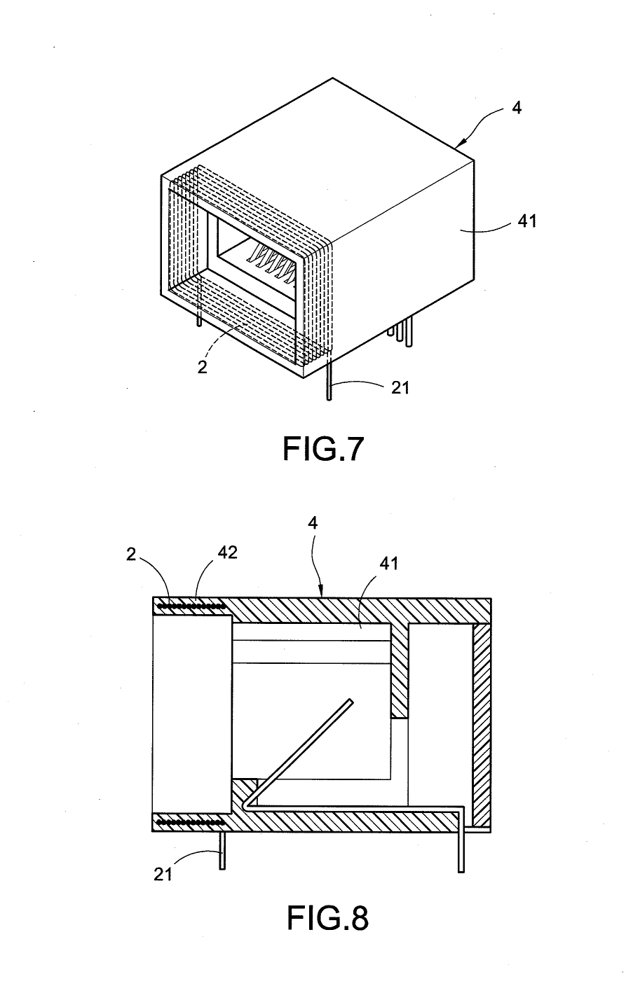

Please refer to FIG. 7. FIG. 7 schematically shows an integration of an outer type antenna structure and a connector of a third embodiment of the invention. As shown in FIG. 7, the integration of the outer type antenna structure and the connector 4 having a plastic housing 41 is completed by mold injection. The antenna 2 is buried in a mold when the mold injection of the plastic housing 41 is performed. The antenna 2 is enveloped in the plastic housing 41 when the mold injection is completed. When the connector 4 is electrically connected to an electronic device (not shown in FIG. 7), the pin 21 extending to outside of the plastic housing 41 is electrically connected to a circuit board of the electronic device.

Please refer to FIG. 8. FIG. 8 schematically shows an integration of an outer type antenna structure and a connector of a fourth embodiment of the invention. As shown in FIG. 8, the integration of the outer type antenna structure and the connector 4 having a plastic housing 41 is completed by mold injection. The antenna 2 of a winding or a plurality of segments is buried in a mold when the mold injection of the plastic housing 41 is performed. The antenna 2 is enveloped in a frame 42 arranged on a rim of an opening of the plastic housing 41 when the mold injection is completed. When the connector 4 is electrically connected to an electronic device (not shown in FIG. 7), the pin 21 extending to outside of the frame 42 is electrically connected to a circuit board of the electronic device.

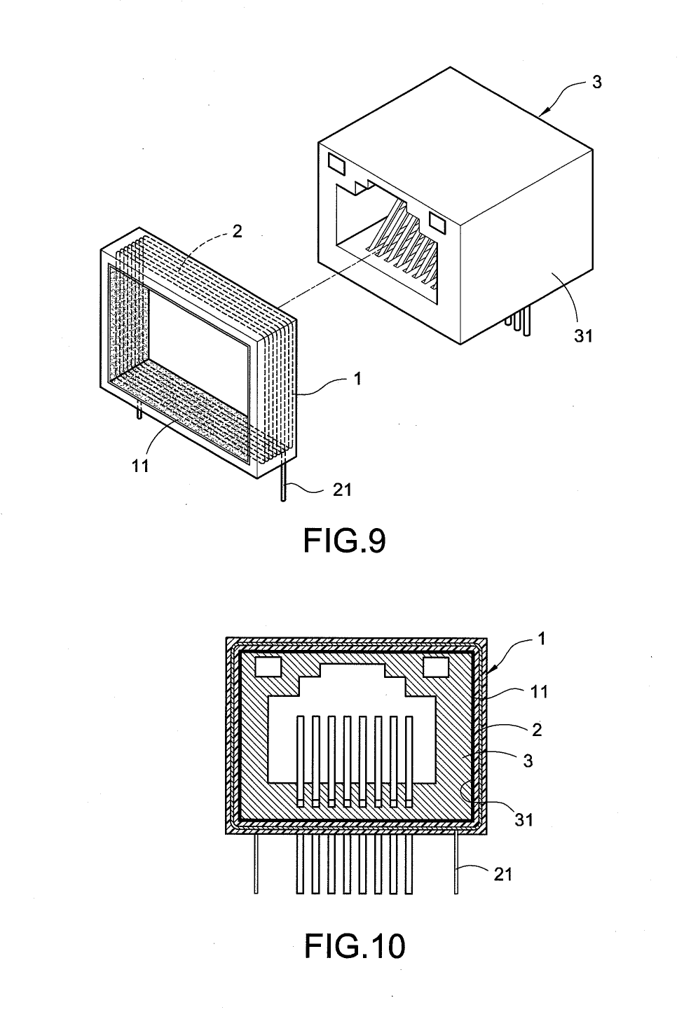

Please refer to FIGS. 9 and 10. FIG. 9 schematically shows a disconnected state of an outer type antenna structure and a connector of a fifth embodiment of the invention. FIG. 10 schematically shows a cross-sectional view of a connected state of an outer type antenna structure and a connector of the fifth embodiment of the invention. As shown in FIG. 9, the frame 1 may further include ferrite or steel which is used as an absorber 11 for absorbing an emitting electric wave. The steel is preferred to have a high permeability. As the frame 1 is integrated to the connector 3 having a metallic case 31, the absorber 11 is disposed between the frame 1 and the case 31. The absorber 11 can enhance the function of antenna 2.

While the invention is described in by way of examples and in terms of preferred embodiments, it is to be understood that the invention is not limited thereto. On the contrary, the aim is to cover all modifications, alternatives and equivalents falling within the spirit and scope of the invention as defined by the appended claims.

What is claimed is:

1. An outer type antenna structure comprising:
a frame; and
an antenna arranged in the frame, the antenna extending to have a pin outside of the frame.

2. The outer type antenna structure as claimed in claim 1, wherein the frame is material of plastics or rubbers.

3. The outer type antenna structure as claimed in claim 2, wherein the antenna is a metallic wire or low temperature co-fired multi-layer ceramic, and the antenna is buried in the frame by a winding or a plurality of segments.

4. The outer type antenna structure as claimed in claim 3, wherein the frame further includes an absorber.

5. The outer type antenna structure as claimed in claim 4, wherein the absorber is ferrite or steel, the steel having a high permeability.

6. An outer type antenna structure comprising:
a connector;
a frame surrounded outside of the connector; and
an antenna arranged in the frame, the antenna extending to have a pin outside of the frame.

7. The outer type antenna structure as claimed in claim 6, wherein the connector further includes a case having material of metal, and the frame surrounds out of the case.

8. The outer type antenna structure as claimed in claim 7, wherein the connector is an electrical connector or a composite electrical connector selected from the group consisting of USB, mini USB, micro USB, HDMI, diplayport and RJ-45 or the connector is a 3.5 mm phone jack.

9. The outer type antenna structure as claimed in claim 8, wherein the frame is material of plastics or rubbers.

10. The outer type antenna structure as claimed in claim 9, wherein the antenna is a metallic wire or low temperature co-fired multi-layer ceramic, and the antenna is buried in the frame by a winding or a plurality of segments.

11. The outer type antenna structure as claimed in claim 10, wherein the frame further includes an absorber.

12. The outer type antenna structure as claimed in claim 11, wherein the absorber is ferrite or steel, the steel having a high permeability.

13. The outer type antenna structure as claimed in claim 10, wherein the connector further includes a case having material of plastic, and the frame surrounds out of the case.

14. An outer type antenna structure comprising:
a connector;
a frame attached on a panel of the connector; and
an antenna arranged in the frame, the antenna extending to have a pin outside of the frame.

15. The outer type antenna structure as claimed in claim 14, wherein the connector further includes a case having material of metal.

16. The outer type antenna structure as claimed in claim 15, wherein the connector may be an electrical connector or a composite electrical connector selected from the group consisting of USB, mini USB, micro USB, HDMI, diplayport and RJ-45 or the connector is a 3.5 mm phone jack.

17. The outer type antenna structure as claimed in claim 16, wherein the frame may be material of plastics or rubbers.

18. The outer type antenna structure as claimed in claim 17, wherein the antenna is a metallic wire or low temperature co-fired multi-layer ceramic, and the antenna is buried in the frame by a winding or a plurality of segments.

19. The outer type antenna structure as claimed in claim 18, wherein the frame further includes an absorber.

20. The outer type antenna structure as claimed in claim 19, wherein the absorber is ferrite or steel, the steel having a high permeability.

21. The outer type antenna structure as claimed in claim 18, wherein the connector further includes a case having material of plastic.

22. An outer type antenna structure comprising:
a connector having a plastic housing; and
an antenna is arranged in the plastic housing, the antenna extending to have a pin outside of the plastic housing.

23. The outer type antenna structure as claimed in claim 22, wherein the connector is an electrical connector or a composite electrical connector selected from the group consisting of USB, mini USB, micro USB, HDMI, diplayport and RJ-45 or the connector is a 3.5 mm phone jack.

24. The outer type antenna structure as claimed in claim 23, wherein the antenna may be a metallic wire or low temperature co-fired multi-layer ceramic, and the antenna is buried in the plastic housing by a winding or a plurality of segments.

25. An outer type antenna structure comprising:
a connector having a plastic housing, the plastic housing having a position on a rim of an opening for disposing a frame; and
an antenna arranged in the frame, the antenna extending to have a pin outside of the frame.

26. The outer type antenna structure as claimed in claim 25, wherein the connector is an electrical connector or a composite electrical connector selected from the group consisting of USB, mini USB, micro USB, HDMI, diplayport and RJ-45 or the connector is a 3.5 mm phone jack.

27. The outer type antenna structure as claimed in claim 26, wherein the antenna may be a metallic wire or low temperature co-fired multi-layer ceramic, and the antenna is buried in the frame by a winding or a plurality of segments.
